(19) United States
(12) Patent Application Publication
(10) Pub. No.: US 2013/0119770 A1
(43) Pub. Date: May 16, 2013

(54) Network Architectures for Distributed Resource Management in Electric Power Systems

(71) Applicant: Jianlin Guo, Newton, MA (US)

(72) Inventor: Jianlin Guo, Newton, MA (US)

(21) Appl. No.: 13/294,452

(22) Filed: Nov. 11, 2011

(51) Int. Cl. H02J 3/00

(52) U.S. Cl. 307/69

(57) ABSTRACT

A network for managing distributed resources (DRs) is connected to an electric power system (EPS). The network includes a set of controllers, and multiple sets of the DRs, wherein each controller is connected to one of the sets of the DRs by a personal area network (PAN). A management system connects the EPS and the set of controllers by a wide area network (WAN). The EPS generates commands for selected DRs to take actions, the commands are routed to the selected DRs via the WAN and PANs.

### FIELD OF THE INVENTION

This invention relates generally to interconnecting distributed resources in electric power systems, and particularly to managing distributed resources in electric power systems.

### BACKGROUND OF THE INVENTION

Distributed resources (DRs) can be used with renewable energy resources and for smart grid development to meet an increase in electric energy demand. As a result, the demand for interconnecting DRs, such as distributed generators and distributed storages, to the electric power systems (EPS) continues to increase.

The impact of interconnecting the DRs to electric power system must be managed, particularly if the number of DRs is large. The IEEE 1547 series standards provide criteria, requirements and guidelines for interconnecting DRs with EPSs, e.g., IEEE 1547 is a baseline standard for interconnecting DRs with EPSs, IEEE 1547.1 describes the testing of the interconnection in order to determine whether or not it conforms to standards, IEEE 1547.2 provides application guide for interconnecting DRs with EPSs, IEEE 1547.3 details guidelines for monitoring of distributed systems, IEEE 1547.4 is a guide for the design, operation, and integration of conforming systems, IEEE 1547.5 is designed for distributed sources larger than 10 MVA, IEEE1547.6 describes practices for secondary network interconnections, IEEE 1547.7 provides guide for conducting impact studies, and IEEE 1547.8 provides methods and procedures for implementation support.

Conventionally, the DRs are characterized as a negative load and a passive device. The EPS has no direct control of the DRs. That is, in the prior art, the DRs generally operate autonomously. However, interconnecting a large number of the DRs to the electric power system leads to high penetration of variable and unmanaged power sources. Without control or management, power quality can be greatly impacted by high penetration of DRs, and damage to power devices and even injury to human are a possibility.

Therefore, the DRs must be made to actively participate in the management of the EPS. However, the unplanned locations, variable capabilities and fluctuating response to the EPS system of the DRs make DRs difficult to be managed by using only conventional control mechanisms in the EPS.

Therefore, it is desired to provide a management system for reliable and efficient management and control of the DRs interconnected to the EPS. To do so, an advanced network and communication capability in the EPS are required.

### SUMMARY OF THE INVENTION

The embodiments of the invention provide a network for managing distributed resources (DRs) connected to an electric power system (EPS) using network interfaces. The network interfaces can be wired or wireless, or combinations thereof.

The network architecture includes three types of network configurations to manage the DRs connected to the EPS.

The embodiments of the invention also provide a control interaction architecture within the DR management network, which categorizes the control interactions into three classes.

The embodiments of the invention provide communication models that can be used within the DR management network.

### BRIEF DESCRIPTION OF THE DRAWINGS

FIG. 1 is a schematic of a network for distributed resources connected to an electric power systems according to embodiments of the invention;

FIG. 2 is a schematic of a control interaction architecture according to embodiments of the invention;

FIG. 3 is a schematic of a communication model for DRs according to embodiments of the invention;

FIG. 4 is a schematic of a communication model for a DR control with a wireless link for both uplink and downlink communications according to embodiments of the invention;

FIG. 5 is a schematic of a communication model for DR control with a dedicated wired link for downlink communications and a dedicated wireless link for uplink communications according to embodiments of the invention; and

FIG. 6 is a schematic of a communication model for DR control with two network interfaces, a wireless link and a wired link, for both uplink and downlink communications according to embodiments of the invention.

### DETAILED DESCRIPTION OF THE PREFERRED EMBODIMENTS

Network Architecture for Managing Distributed Resources in Electric Power Systems

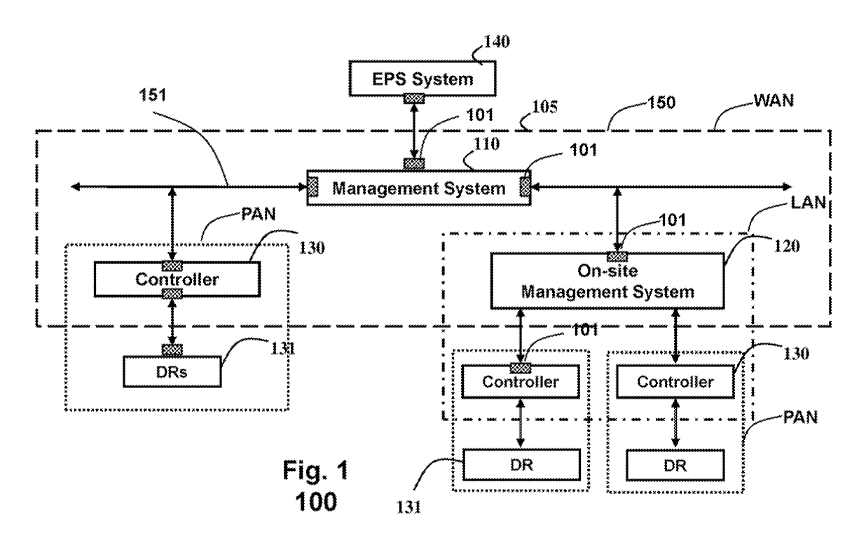

As shown in FIG. 1, the embodiments of the invention provide a network 100 and a control interaction architecture for managing distributed resources (DRs) 131 connected to an electric power systems (EPS) 140 to realize reliable and efficient operation of the DRs and the EPS.

The network 100 includes: a management system 110, an on-site management system 120, a set of controllers 130, and a set of DRs 131, wherein each set of DRs is connected to one controller. The DRs can be distributed generators and distributed storages. Of particular interest are renewable energy resources such as produced by sunlight, wind, rain, tides, geothermal heat, etc. As used herein a set includes one or more members.

The network also includes communication interfaces 101, some of which are shown.

The network can be a wide area network (WAN) 150 that uses two-way communications 151, which can be wired, wireless, or combinations thereof. The network can also include personal or local area networks (PAN, LAN).

WAN, LAN, PAN

As defined herein, a WAN spans a large geographic area, e.g., the Internet. A WAN is a dispersed collection of LANs connected by routers. Most WANs exist under collective or distributed ownership and management.

In contrast, a LAN connects devices over a relatively short distance, as in an office building, or industrial facility. A LAN can span a group of nearby buildings and can be implemented as a single Internet protocol (IP) subnet. LANs are also typically owned, controlled, and managed by a single entity and use connectivity technologies such as the Ethernet and token ring.

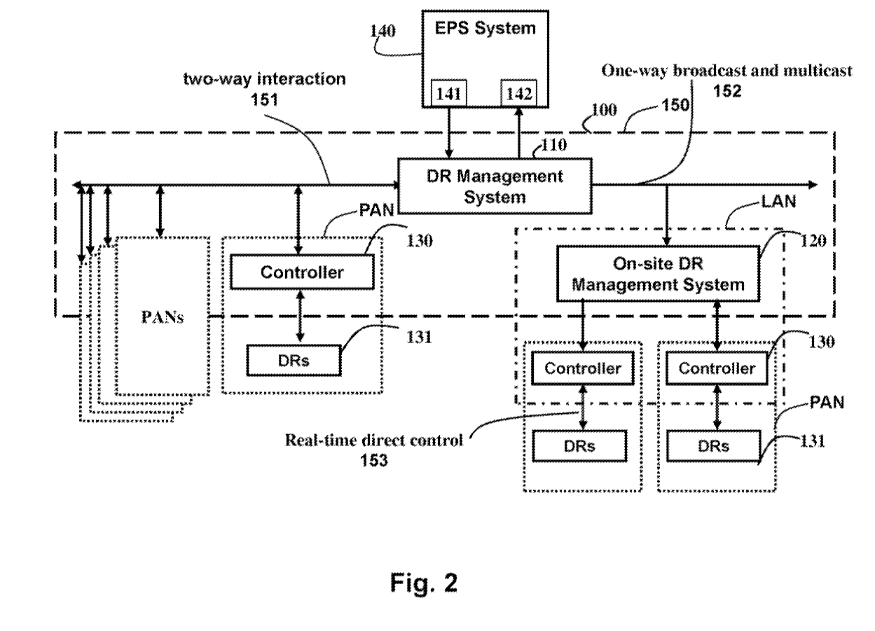

A PAN is typically used for communication between devices in close proximity, e.g., a few meters. The PAN can be connected to a higher level networks, such as LANs and WANS. As shown in FIG. 2, the number of PANs in future power systems is anticipated to increase dramatically, to the point where conventional autonomous local control of DRs clearly becomes untenable,

The management system controls operations of the DRs based on a status of the EPS and the DRs, e.g., to prevent islanding. During islanding, a distributed generator continues to power a location even though the electrical grid from an electric utility is no accessible. Islanding can be dangerous to utility workers and users, who can not realize that a circuit is still powered, and it can prevent automatic re-connection of devices. For that reason, distributed generators must detect islanding and immediately stop producing power.

The optional on-site management system 120 operates where a cluster of the DRs located, and is desirable where multiple DRs are located, e.g., medical and industrial facilities.

The controller 130 operates at point where the DRs are located. Functions of the controller can be implemented in a dedicated control device or can be integrated virtually in a processor of an intelligent DR.

Based on the locations of the DRs, the number of the DRs and common connection point of the DRs, three types of network configurations can be used within the DR management network.

FIG. 1 shows an example network architecture in which management system, the on-site management systems and some controllers form the WAN, the on-site management system and some controllers form the LAN, and the controller together with its DRs, such as distributed generators and distributed storages, form the PAN. As mentioned above, a controller can be a dedicated control device or an intelligent DR.

Any variations of FIG. 1 can be used within a DR management network. In addition, the management system also has network interface with the EPS.

Each network interface 101 supports two way communications, which can be implemented by using common network interfaces for two way communications or dedicated one way network interfaces to support two way communications, e.g., a transceiver. Any wired medium, such as power line and Ethernet cable, and/or wireless medium, such as WiFi radio and GSM radio, can be used for communication between any components within the DR management network. High priority control commands and status reports are reliably delivered to destinations without undue delay.

Control Interactions within the DR Management Network

The control interactions between the EPS and the management system can be categorized as real-time direct control 153, two-way interaction 151, and one-way broadcast and multicast 152 as shown in FIG. 2.

Real-Time Direct Control

Real-time direct control directly controls and monitors of the DRs by the controllers. In the control case, the management system requires real time response from the DRs. In the monitor case, the DRs reports real time status to the management system. A highly available communication channel is required to achieve real-time direct control.

FIG. 2 shows real-time direct control between controllers and the controlled DRs. In general, control interaction between the controller and the DRs is real-time direct control because the DRs depend on the controller for their operations. The real-time direct control can also be applied between management system and the controller. In this case, the controller performs real-time direct control to the DRs. As a result, the real-time direct control operation is achieved between the management system and the DRs. For example, if the management system detects islanding, it can request the DRs to stop producing power immediately.

Two-Way Interaction

During the two-way interaction, command data from a transmitter are interpreted by a receiver to undertake actions. The receiver then reports to the transmitter about actions performed. Real-time response is not required, so some delay is acceptable.

FIG. 2 shows two-way interaction between the management system and the controller, and between the on-site management system and the controller. Two-way interaction can also be used between the controller and the DRs. For example, the controller can transmit a command to the DR to schedule a future action and request the DR to report when the action is performed.

One-Way Broadcast and Multicast

With one-way broadcast and multicast, the command data from the transmitter are destined to multiple receivers. A response is not expected from the receiver. Then, receivers interpret the command data and undertake actions. For example, if the management system detects islanding, it can broadcast a command to stop producing power immediately.

FIG. 2 shows one-way broadcast/multicast between the management system and the on-site management systems, and between on-site management system and controllers. One-way broadcast/multicast can also be used between the controller and the DRs. For example, a controller can broadcast periodic status information to its DRs.

FIG. 2 is a typical control interaction architecture for managing DRs in EPS. Any variations of FIG. 2 can be applied within a DR management network.

Communication Models for the DR Management Network

The communications in the DR management network includes uplink (UL) communications and downlink (DL) communications. For the management system, the UL communication is with the EPS, and the DL communication is with the controller or the on-site management system.

For the on-site management system, the UL communication is with the management system, and the DL communication is with the controller. For the controller, the UL communication is with the management system or the on-site management system, and DL communication is with the DR. For the DR, there is only UL communication with the controller.

Component Classes

The primary components of the DR management network can be categorized into two classes, that is, the controllers 130 and the set of DRs 131, such as distributed generators and distributed storages.

To perform DR management, the DR undertake actions upon receiving control command, and then report the status and the result based on the control interactions, i.e., real-time direct control, two-way interaction, or one-way broadcast/multicast.

Communication Model

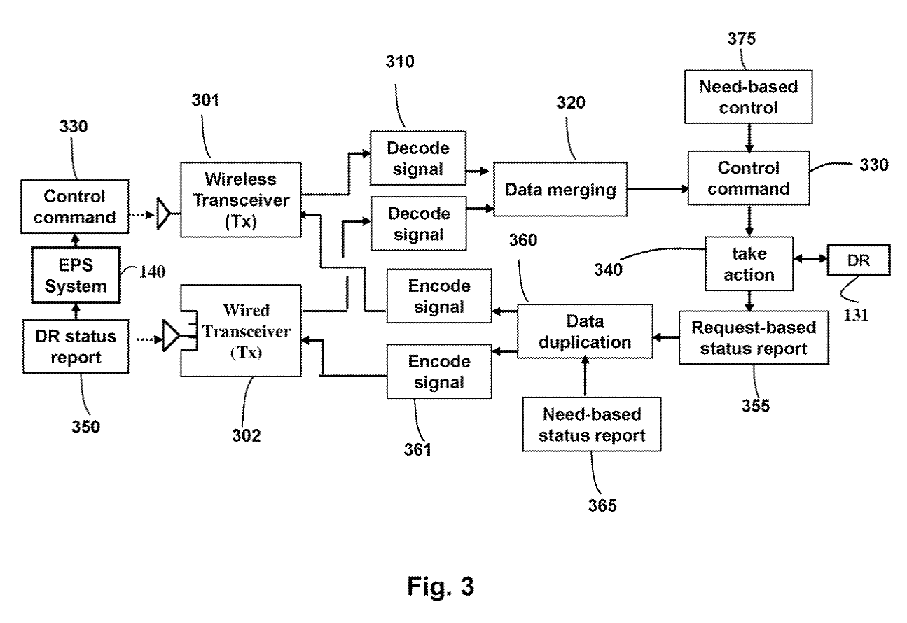

As shown in FIG. 3, a common communication model can be implemented for all controllers and DRs to satisfy the need of each controller or DR. The communication model includes a wireless transceiver 301 and a wired transceiver 302. The transmitter and receiver can be implemented as a transceiver (Tx) having both transmit and receive capabilities.

In the network according to embodiments of the invention, the EPS 140 includes means 141 for generating control commands 330. The destination of the command is one or more selected DRs, depending of the type of control interaction. For example, the command can be transmitted to a single DR for real-time direct control, or multiple DRs in broadcast or multicast mode.

The control command is routed via the management system and the controllers to the appropriate DRs. The DR(s) takes the action 340 specified in the command.

In response, a DR status report 350, request-based status report 355 or need-based status report 365, can be generated, which is transmitted back means 142 for receiving the report in the EPS, as described in further detail below. The means 141-142 can be implemented as application programs executed in a processor of the EPS.

In the embodiment shown in FIG. 3, data pertaining to the command, and received from the wireless link and the wired link, are decoded 310 and then merged 320. The data can be carried in formatted packets as known in the art. The packet includes a source address and a destination address.

If both links correctly receive copies of same control data, then one of copy is discarded and one copy is used as the control command 330 to take actions 340 in the DR.

If one link receives a correct control data and the other link receives data with an error, the correct copy of the control data are used as instructions for taking actions. If only one link receives correct control data, this data are used as instructions to take actions.

After performing the requested actions, the DR constructs a request-based status report 355 for the corresponding UL transceiver. This status report is duplicated 360. After encoding 361, one copy is transmitted using the wireless link, and the other copy is transmitted using the wired link to ensure reliable delivery.

In addition to the control command received from wireless link or wired link, the control command 330 can also be generated based on need-based control 375. Similarly, the DR can also generate the need-based status report 365 when it is necessary in addition to the request-based status report 355.

The configuration of the communication model depends on the network interfaces at each controller or DR. For example, if the DR is only equipped with a wired interface, the common communication model is configured to only use the wired interface. All other interfaces are configured to be off.

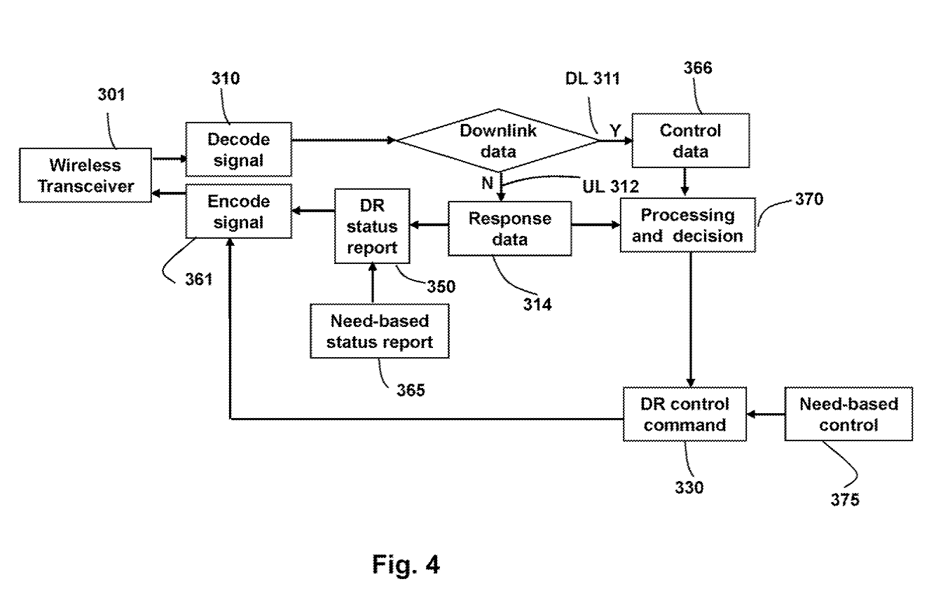

FIG. 4 shows a communication model in which a single wireless link is used for both UL and DL communications. When data are received via the wireless transceiver, after decoding, first determine if the packet contains DL data 311 or UL data 312.

If the packet contains UL data 312, then a DR status report 350 is generated based on response data 314, encoded 361 and transmitted to the corresponding UL receiver. Response data 314 are then processed 370 further. If necessary, a DR control command 330 can be constructed, encoded 361 and transmitted to the corresponding DL receivers.

in addition, a DR status report 350 can also be generated based on need-based status report 365 and transmitted to the corresponding UL receiver.

If the packet contains DL data 311, the data are control data 366. The control data are processed 370 and the DR control command 330 is constructed and transmitted to corresponding DL receiver.

In addition, a DR control command 330 can also be generated based on need-based control 375 of DRs and transmitted to the corresponding DL receiver.

The DR management network can use a dedicated network interface for the UL communications and another dedicated network interface for the DL communications.

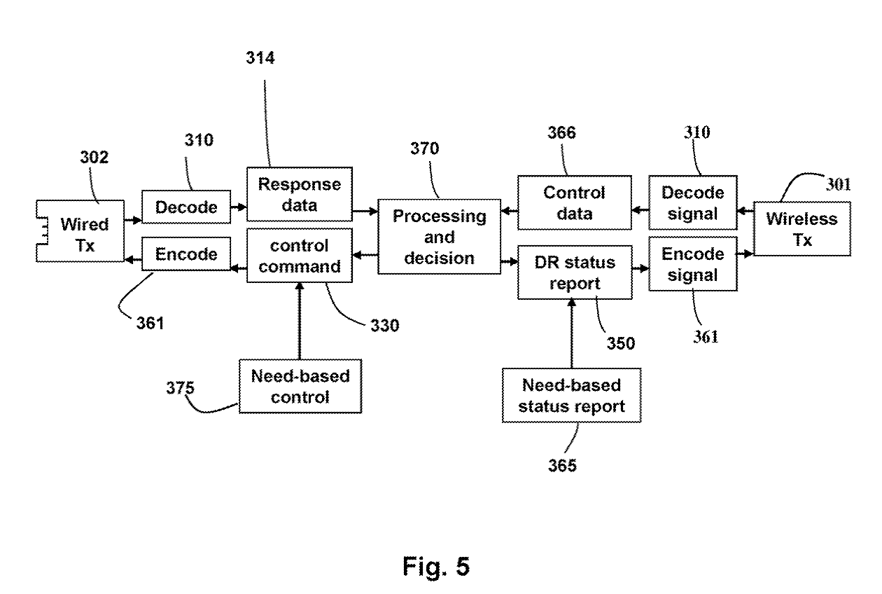

FIG. 5 shows a communication model, in which the wired link is used for DL communications and the wireless link is used for UL communications. When a packet containing response data are received from the wired link 302, the response data are processed, the DR status report 350 is constructed and transmitted to corresponding UL receiver via the wireless link 301. Based on the received response data, a new DR control command 330 can also be constructed and transmitted to the corresponding DL receiver via wired link 302 for further DR control. When a packet contains control data are received via wireless link 301, the control data are processed, a new DR control command 330 is constructed and transmitted to the corresponding DL receivers via the wired link 302. In addition, need-based control of set of DRs can be used. In this case, a new DR control command is constructed and transmitted to the corresponding DL receiver via the wired link 302. Similarly, the need-based status report 365 can also be constructed. In this case, the DR status report 350 is constructed and transmitted to the corresponding UL receiver via the wireless link 301.

The DR management network can also use multiple network interfaces for UL and/or DL communications. Multiple network interfaces can be used concurrently, or one network interface is selected as a primary interface and the other interfaces can be used for backup. For example, a power line can be used as the primary network interface, and a wireless transceiver can be used as for the backup network interface.

In case a fault is detected in the EPS, some switches can be set off so that the power line can no longer be used as a communication medium. During this case, a wireless transceiver is used for communication.

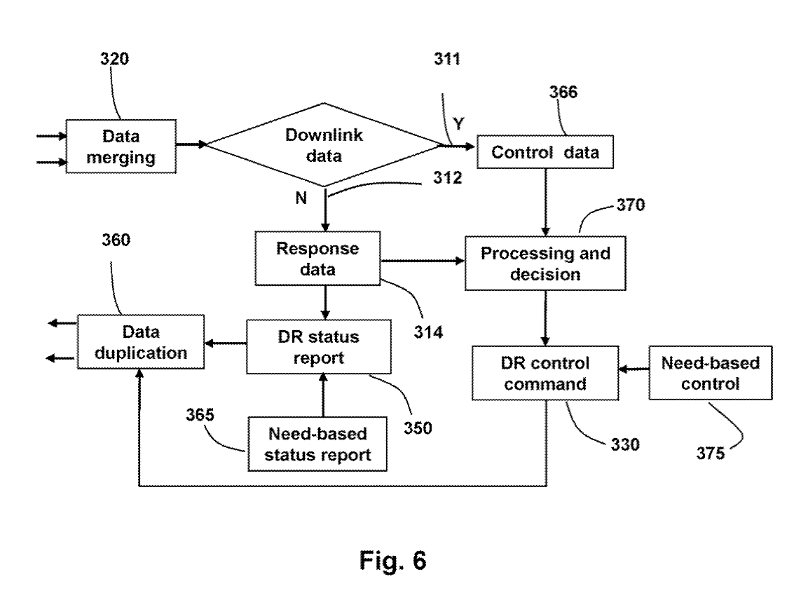

FIG. 6 shows a communication model, in which the wireless link and the wired link are used for both UL and DL communications. The differences between FIG. 4 and FIG. 6 are duplicated receiving and duplicated transmission.

It is not necessary for all components within a DR management network to be equipped with same network interfaces. For example, the network can use a wireless interface and a wired interface, one controller can use a single wireless interface and another controller can use a single wired interface.

### Effect of the Invention

The invention provides a network for managing a set of distributed resources (DRs) connected to an electric power system (EPS) using network interfaces. The network interfaces can be wired or wireless, or combinations thereof. The invention is particularly useful where a large number of DRs are connected to the EPS by a power grid, and the set of DRs are distributed over a large geographic area.

Instead of operating the local DRs autonomously and individually, as in the conventional power systems, the invention provides a management system that interfaces the DRs to the EPS. The management system uses a WAN to communicate with controllers, where each controller at a particular location is connected to one or more DRs. The management system uses wired and wireless interfaces to provide reliable real-time communication links.

Although the invention has been described by way of examples of preferred embodiments, it is to be understood that various other adaptations and modifications may be made within the spirit and scope of the invention. Therefore, it is the object of the appended claims to cover all such variations and modifications as come within the true spirit and scope of the invention.

We claim:

1. A network for managing distributed resources (DRs) connected to an electric power system (EPS), comprising:
a set of controllers;
a plurality of sets of the DRs, wherein each controller is connected to one of the sets of the DRs by a personal area network (PAN);
a management system connected to the EPS and the set of controllers by a wide area network (WAN), wherein the EPS generates commands for selected DRs to take actions, the commands are routed to the selected DRs via the WAN and PANs.

2. The network of claim 1, further comprising:
a plurality of communication interfaces for interconnecting the sets of the DRs, the set of controllers, the management system, and the EPS.

3. The network of claim 1, wherein the WAN uses one-way or two-way communication interactions

4. The network of claim 1, wherein the controllers provide real-time direct control of the DRs.

5. The network of claim 1, further comprising:
an on-site management system connected to a subset of the controllers using a local area network (LAN).

6. The network of claim 1, wherein a particular controller is implemented in one of the DRs.

7. The network of claim 1, wherein a particular communication interface includes a wired and a wireless transceiver to receive duplicate copies of the command.

8. The network of claim 1, wherein the DRs generate a status report in response to the commands.

9. The network of claim 8, wherein the status report is need-based.

10. The network of claim 8, wherein the status report is request-based.

11. The network of claim 1, wherein the DRs include generator and storages.

12. The network of claim 4, wherein the real-time direct control is initiated by the EPS.

13. The network of claim 1, wherein the management system prevents islanding.
